(19) United States
(12) Patent Application Publication
(10) Pub. No.: US 2024/0255628 A1
(43) Pub. Date: Aug. 1, 2024

(54) ABNORMALITY DETECTION APPARATUS, CONTROL METHOD, AND COMPUTER-READABLE MEDIUM

(71) Applicant: NEC Corporation, Minato-ku, Tokyo (JP)

(72) Inventor: Yoshimasa ONO, Tokyo (JP)

(73) Assignee: NEC Corporation, Minato-ku, Tokyo (JP)

(21) Appl. No.: 18/560,769

(22) PCT Filed: May 21, 2021
(86) PCT No.: PCT/JP2021/019447

§ 371 Date: Nov. 14, 2023

(51) Int. Cl. G01S 7/497; G01S 17/42

(52) U.S. Cl. CPC G01S 7/497; G01S 17/42

(57) ABSTRACT

Abnormality detection apparatus acquires reference point cloud data and inspection point cloud data for each of a plurality of parts in a space including a target object. The reference point cloud data includes point data representing a three-dimensional position and luminance at reference time for each of a plurality of parts. The inspection point cloud data includes point data representing a three-dimensional position and luminance at time of inspection for each of the plurality of parts. The abnormality detection apparatus generates difference point cloud data representing a difference in luminance between the reference time and the time of inspection for each of the parts, detects an excluded part to be excluded from a detection target of an abnormal part, and detects an abnormal part of the target object from the parts other than the excluded parts by using the difference point cloud data.

### TECHNICAL FIELD

The present disclosure relates to a technique for detecting abnormality of an object.

### BACKGROUND ART

A technique for detecting an abnormality of a facility or the like by using point cloud data representing a three-dimensional position and luminance for each of a plurality of parts in a space is developed. For example, Patent Literature 1 discloses a technique of classifying a measurement target into clusters for each structure by using position information at a plurality of points on a surface of the measurement target, and determining an abnormality of the surface of the cluster based on reflected luminance values at the plurality of points on the surface of each cluster.

### CITATION LIST

### Patent Literature

Patent Literature 1: International Patent Publication No. WO 2020/203263

### SUMMARY OF INVENTION

### Technical Problem

An objective of the present disclosure is to provide a new technique of using point cloud data representing a three-dimensional position and luminance for each of a plurality of parts in a space to detect an abnormality of an object positioned in the space.

### Solution to Problem

An abnormality detection apparatus according to the present disclosure includes: an acquisition unit configured to acquire reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts; a difference data generation unit configured to generate difference point cloud data representing a difference in luminance between the reference time and the time of inspection for each of the parts by using the reference point cloud data and the inspection point cloud data; an excluded part detection unit configured to detect a moving object part, which is a part whose position changes over time, from the plurality of parts as an excluded part to be excluded from a detection target of an abnormal part; and an abnormal part detection unit configured to detect an abnormal part of the target object at the time of inspection from the parts other than the excluded parts from the plurality of parts by using the difference point cloud data.

A control method of the present disclosure is executed by a computer. The control method includes: an acquisition step of acquiring reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts; a difference data generation step of generating difference point cloud data representing a difference in luminance between the reference time and the time of inspection for each of the parts by using the reference point cloud data and the inspection point cloud data; an excluded part detection step of detecting a moving object part, which is a part whose position changes over time, from the plurality of parts as an excluded part to be excluded from a detection target of an abnormal part; and an abnormal part detection step of detecting an abnormal part of the target object at the time of inspection from the parts other than the excluded parts from the plurality of parts by using the difference point cloud data.

A computer-readable medium of the present disclosure stores a program causing a computer to execute the control method of the present disclosure.

### Advantageous Effects of Invention

According to the present disclosure, a new technique of using point cloud data representing a three-dimensional position and luminance for each of a plurality of parts in a space to detect an abnormality of an object positioned in the space is provided.

### BRIEF DESCRIPTION OF DRAWINGS

FIG. 1 is a diagram illustrating an overview of an operation of an abnormality detection apparatus of a first example embodiment.

FIG. 2 is a block diagram illustrating a functional configuration of the abnormality detection apparatus of the first example embodiment.

FIG. 3 is a block diagram illustrating a hardware configuration of a computer that realizes the abnormality detection apparatus.

FIG. 4 is a flowchart illustrating a flow of a processes executed by the abnormality detection apparatus of the first example embodiment.

FIG. 5 is a diagram conceptually illustrating a method of generating point cloud data by using electromagnetic waves.

FIG. 6 is a diagram illustrating the influence of a size of an incident angle of the electromagnetic wave on a measurement result.

FIG. 7 is a diagram illustrating the influence of the size of the incident angle of the electromagnetic wave on the measurement result.

FIG. 8 is a diagram illustrating a case where an edge of an object is irradiated with an electromagnetic wave.

FIG. 9 is a diagram illustrating a case where the edge of the object is irradiated with an electromagnetic wave.

FIG. 10 is a diagram conceptually illustrating a process of determining whether point data represents a point on the edge of an object.

FIG. 11 is a diagram conceptually illustrating a process of determining whether the point data represents the point on the edge of the object.

FIG. 12 is a diagram conceptually illustrating a process of determining whether the point data represents the point on the edge of the object.

FIG. 13 is a diagram illustrating a difference in density of point cloud between reference point cloud data and inspection point cloud data.

### EXAMPLE EMBODIMENT

Hereinafter, am example embodiment of the present disclosure is described in detail with reference to the drawings. In the drawings, the same or corresponding elements are denoted by the same reference numerals, and repeated description is omitted as necessary for clarity of description. In addition, unless otherwise described, values determined in advance such as predetermined values and thresholds are stored in advance in a storage device or the like accessible from a device using the values. Furthermore, unless otherwise described, a storage unit includes one or more storage devices of any number.

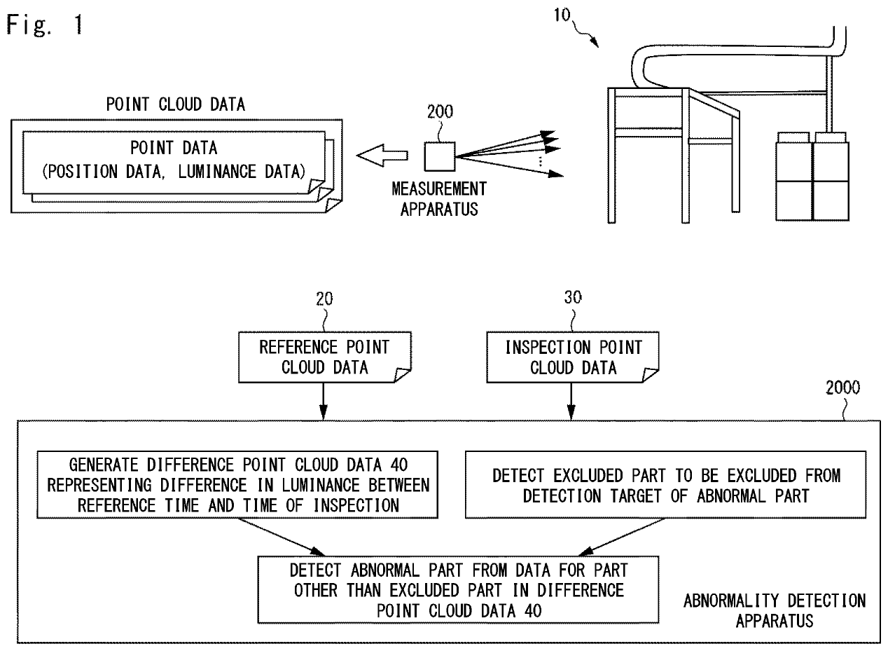

FIG. 1 is a diagram illustrating an overview of an operation of an abnormality detection apparatus 2000 of a first example embodiment. Here, FIG. 1 is a diagram for facilitating understanding of the overview of the abnormality detection apparatus 2000, and the operation of the abnormality detection apparatus 2000 is not limited to that illustrated in FIG. 1.

The abnormality detection apparatus 2000 is used to detect an abnormal part on a target object 10. The target object 10 is an arbitrary object used in a state where a position thereof is fixed and is, for example, the whole or a portion of a facility (structure or building) such as an electric power facility, a steel facility, or a chemical factory. However, the target object 10 is not necessarily limited to one classified as real property and may be classified as movable property.

The abnormality detection apparatus 2000 acquires point cloud data that is a set of point data of each one of a plurality of parts in a target space including the target object 10. The point data of each part indicates position data representing the three-dimensional position of that part and luminance data representing the luminance of that part.

The point cloud data is generated by a measurement apparatus 200. For example, the measurement apparatus 200 generates point cloud data by measurement using electromagnetic waves such as laser light. The measurement apparatus 200 using electromagnetic waves is, for example, light detection and ranging (LiDAR).

Note that the point cloud data may be raw data representing the result of measurement by the measurement apparatus 200 as it is or may be data obtained by applying an arbitrary processing process to the raw data. The processing process to the raw data is, for example, a process of applying coordinate transformation to each position data so that a specific position of the target space becomes an origin.

Here, the abnormality detection apparatus 2000 acquires at least two types of point cloud data named reference point cloud data 20 and inspection point cloud data 30, which are generated for the target space at different points in time. The inspection point cloud data 30 is point cloud data obtained by measurement performed at a point in time when the presence or absence of an abnormal part is desired to be inspected (hereinafter, time of inspection). The reference point cloud data 20 is point cloud data obtained by measurement performed at a point in time before the time of inspection and is used as a reference at the time of abnormality detection. Hereinafter, a point in time when measurement for obtaining the reference point cloud data 20 is performed is referred to as reference time. Note that the state of the target object 10 at the reference time is not necessarily a state in which there is no abnormality at all.

The abnormality detection apparatus 2000 generates difference point cloud data 40 by using the reference point cloud data 20 and the inspection point cloud data 30. The difference point cloud data 40 indicates difference point data that represents a difference in luminance between the time of inspection and the reference time, for each of the plurality of parts in the target space.

The abnormality detection apparatus 2000 detects an abnormal part of the target object 10 from the plurality of parts in the target space by using the difference point cloud data 40. At that time, the abnormality detection apparatus 2000 excludes a part that satisfies a specific condition among the plurality of parts in the target space from an abnormality detection target. Here, the part excluded from the abnormality detection target is referred to as an excluded part. The abnormality detection apparatus 2000 detects the abnormal part by using the difference point cloud data 40 regarding the parts other than the excluded parts.

For example, the excluded part is a part whose position changes over time in the target space (hereinafter, referred to as a moving object part). The abnormality detection apparatus 2000 detects a moving object part by using the inspection point cloud data 30 and handles the detected moving object part as an excluded part.

In addition, for example, the excluded part is a part that is prone to erroneous determination in determination on whether the part is an abnormal part. As described below, the part prone to erroneous determination is, for example, a part where an incident angle of the electromagnetic wave emitted from the measurement apparatus 200 is large, or a part near the edge of the object.

### Example of Advantageous Effect

With the abnormality detection apparatus 2000 of the present example embodiment, the abnormal part is detected by using the point cloud data indicating the three-dimensional position and the luminance of each of the plurality of parts in the space including the target object 10. At that time, the detection of the abnormal part is performed on parts other than the excluded parts satisfying a specific condition. In this way, it is possible to detect the abnormal part of the target object 10 with higher accuracy.

For example, the abnormality detection apparatus 2000 handles a moving object part as an excluded part. Here, the measurement for obtaining the point cloud data is performed on the target space including the target object 10. Therefore, the point cloud data may also include point data of objects other than the target object 10. Therefore, it is preferable that the detection target of the abnormal part can be limited to only the target object 10 by excluding the point data other than the target object 10 from the detection target of the abnormal part.

In this regard, since the target object 10 is a facility or the like whose position is fixed, it is likely that the moving object part is a portion of an object (for example, grass, tree, or the like) other than the target object 10. Therefore, by excluding the moving object part from the abnormality detection target, the likelihood that the abnormal part is detected for the object other than the target object 10 can be reduced. In other words, it is possible to increase the likelihood that the part detected as the abnormal part is a portion of the target object 10. Therefore, it is possible to detect an abnormal part targeted at the target object 10 with higher accuracy.

In addition, for example, the abnormality detection apparatus 2000 handles a part prone to erroneous determination as an excluded part. In this way, it is possible to lower the likelihood that a part that is not an abnormal part is erroneously detected as an abnormal part.

Hereinafter, the abnormality detection apparatus 2000 of the present example embodiment is described in more detail.

### <Example of Functional Configuration>

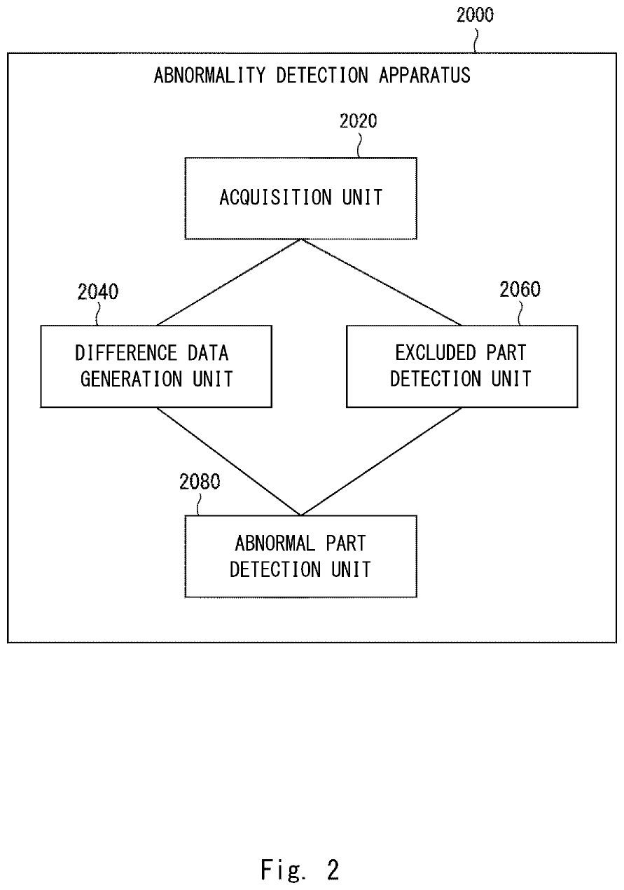

FIG. 2 is a block diagram illustrating a functional configuration of the abnormality detection apparatus 2000 of the first example embodiment. The abnormality detection apparatus 2000 includes an acquisition unit 2020, a difference data generation unit 2040, an excluded part detection unit 2060, and an abnormal part detection unit 2080. The acquisition unit 2020 acquires the reference point cloud data 20 and the inspection point cloud data 30. The difference data generation unit 2040 generates difference point cloud data 40 by using the reference point cloud data 20 and the inspection point cloud data 30. The excluded part detection unit 2060 detects the excluded part by using one or both of the reference point cloud data 20 and the inspection point cloud data 30. The abnormal part detection unit 2080 detects an abnormal part by using data of the parts other than the excluded parts in the difference point cloud data 40.

### <Example of Hardware Configuration>

Each functional configuration unit of the abnormality detection apparatus 2000 may be realized by hardware that realizes each functional configuration unit (for example, a hard-wired electronic circuit) or may be realized by a combination of hardware and software (for example, a combination of an electronic circuit and a program that controls the electronic circuit or the like). Hereinafter, a case where each functional configuration unit of the abnormality detection apparatus 2000 is realized by a combination of hardware and software is further described.

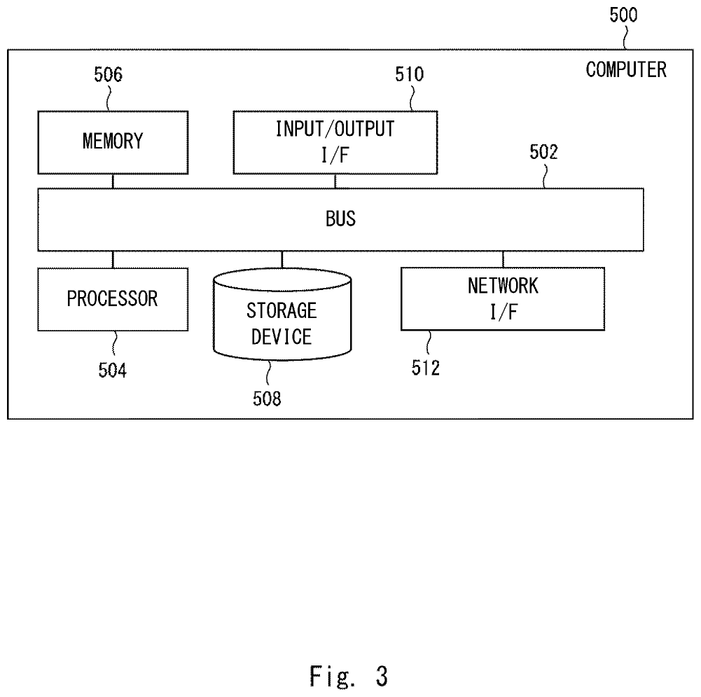

FIG. 3 is a block diagram illustrating a hardware configuration of a computer 500 that realizes the abnormality detection apparatus 2000. The computer 500 is any computer. For example, the computer 500 is a stationary computer such as a personal computer (PC) or a server machine. In addition, for example, the computer 500 is a portable computer such as a smartphone or a tablet terminal. The computer 500 may be a special-purpose computer designed to realize the abnormality detection apparatus 2000 or may be a general-purpose computer.

For example, by installing a predetermined application in the computer 500, each function of the abnormality detection apparatus 2000 is realized by the computer 500. The above-described application is configured with a program for realizing the functional configuration units of the abnormality detection apparatus 2000. Note that the method of acquiring the program is arbitrary. For example, the program can be acquired from a storage medium (a DVD disk, a USB memory, or the like) in which the program is stored. In addition, for example, the program can be acquired by downloading the program from a server apparatus that manages a storage device in which the program is stored.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, the method of connecting the processor 504 and the like to each other is not limited to the bus connection.

The processor 504 is various processors such as a central processing unit (CPU), a graphics processing unit (GPU), or a field-programmable gate array (FPGA). The memory 506 is a main storage device realized by using a random access memory (RAM) or the like. The storage device 508 is an auxiliary storage device realized by using a hard disk, a solid state drive (SSD), a memory card, read only memory (ROM), or the like.

The input/output interface 510 is an interface for connecting the computer 500 and an input/output device. For example, an input apparatus such as a keyboard and an output apparatus such as a display apparatus are connected to the input/output interface 510.

The network interface 512 is an interface for connecting the computer 500 to a network. The network may be a local area network (LAN) or may be a wide area network (WAN).

The storage device 508 stores a program (program for realizing the above-described application) for realizing each functional configuration unit of the abnormality detection apparatus 2000. The processor 504 reads the program to the memory 506 and executes the program to realize each functional configuration unit of the abnormality detection apparatus 2000.

The abnormality detection apparatus 2000 may be realized by one computer 500 or may be realized by the plurality of computers 500. In the latter case, the configurations of the computers 500 do not need to be the same and can be different from each other.

### <Flow of Process>

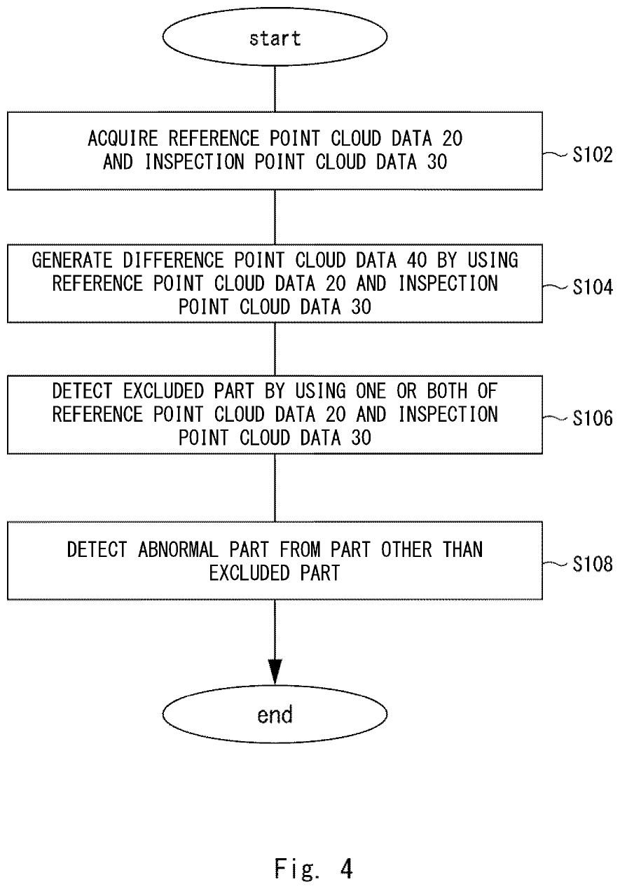

FIG. 4 is a flowchart illustrating a flow of processes executed by the abnormality detection apparatus 2000 of the first example embodiment. The acquisition unit 2020 acquires the reference point cloud data 20 and the inspection point cloud data 30 (S102). The difference data generation unit 2040 generates the difference point cloud data 40 using the reference point cloud data 20 and the inspection point cloud data 30 (S104). The excluded part detection unit 2060 detects the excluded part using one or both of the reference point cloud data 20 and the inspection point cloud data 30 (S106). The abnormal part detection unit 2080 detects an abnormal part from the parts other than the excluded parts (S108).

Here, the flowchart illustrated in FIG. 4 is merely an example, and the flow of the processes executed by the abnormality detection apparatus 2000 is not limited to the flow illustrated in FIG. 4. For example, the abnormality detection apparatus 2000 may perform the process of detecting an excluded part (S106) before the process of generating the difference point cloud data 40 (S104). In this case, the difference data generation unit 2040 may generate the difference point cloud data 40 by targeting only a part other than the excluded parts. In addition, for example, the process of generating the difference point cloud data 40 (S104) and the process of detecting an excluded part (S106) may be performed in parallel with each other.

### <Regarding Point Cloud Data>

For example, the measurement apparatus 200 measures a three-dimensional position and luminance by using electromagnetic waves such as laser light. Specifically, the measurement apparatus 200 emits electromagnetic waves in a plurality of different directions and receives reflected waves which are the electromagnetic waves reflected by an object for the respective electromagnetic waves. Then, the measurement apparatus 200 generates point data representing a three-dimensional position and luminance of a part where the electromagnetic wave is reflected based on a relationship between the emitted electromagnetic wave and the reflected wave thereof.

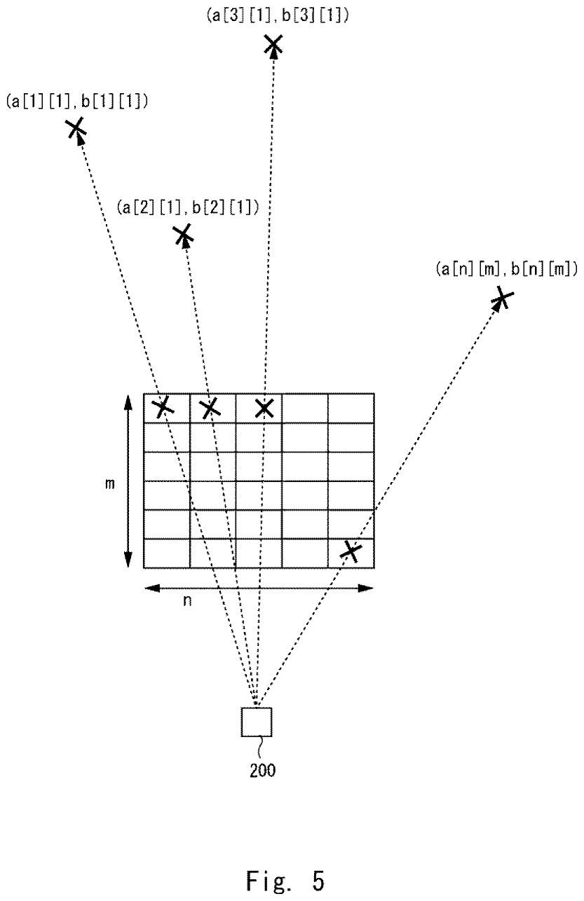

FIG. 5 is a diagram conceptually illustrating a method of generating point cloud data by using electromagnetic waves. Dotted arrows represent electromagnetic waves emitted from the measurement apparatus 200. Cross marks represent parts where electromagnetic waves are reflected.

In FIG. 5, the emission directions of the electromagnetic waves are represented by positions of cells of the grid through which the electromagnetic waves pass. Specifically, by using an index i representing the emission direction with respect to the horizontal direction and an index j representing the emission direction with respect to the vertical direction, the emission direction of the electromagnetic wave is denoted by (i, j).

In FIG. 5, there are n emission directions of the electromagnetic wave in the horizontal direction and m emission directions in the vertical direction. Thus, the measurement apparatus 200 emits electromagnetic waves in different n*m directions. Therefore, with the measurement apparatus 200, point cloud data having n*m pieces of point data is obtained. In other words, the resolution of the measurement apparatus 200 is n*m.

Hereinafter, the point data obtained by the electromagnetic wave emitted in the direction (i, j) is represented as p[i][j]=(a[i][j], b[i][j]). a[i][j] represents a three-dimensional position of a part at which the electromagnetic wave emitted in the direction (i, j) is reflected. b[i][j] represents the luminance of the part at which the electromagnetic wave emitted in the direction (i, j) is reflected. According to this notation, point cloud data P can be expressed as P={p[i][j]=(a[i][j], b[i][j])|1<=i<=n, 1<=j<=m}. Note that a way of the notation described here is an example for facilitating the following description, and a way of denoting the point data and the point cloud data is not limited to the way described here.

### <Acquisition of Point Cloud Data: S102>

The acquisition unit 2020 acquires the reference point cloud data 20 and the inspection point cloud data 30 (S102). There are various methods by which the acquisition unit 2020 acquires these point cloud data. For example, the reference point cloud data 20 and the inspection point cloud data 30 are stored in advance in a storage unit accessible from the abnormality detection apparatus 2000. The acquisition unit 2020 acquires the reference point cloud data 20 and the inspection point cloud data 30 by accessing the storage unit.

In addition, for example, the reference point cloud data 20 and the inspection point cloud data 30 may be input to the abnormality detection apparatus 2000 in response to a user operation. For example, the user connects a portable storage unit (such as a memory card) in which the reference point cloud data 20 and the inspection point cloud data 30 are stored to the abnormality detection apparatus 2000, and inputs the reference point cloud data 20 and the inspection point cloud data 30 from the storage unit to the abnormality detection apparatus 2000.

In another example, the acquisition unit 2020 may acquire the reference point cloud data 20 and the inspection point cloud data 30 by receiving the reference point cloud data 20 and the inspection point cloud data 30 transmitted from another apparatus. For example, the other apparatus is the measurement apparatus 200, an apparatus that processes raw data generated by the measurement apparatus 200 to generate the reference point cloud data 20 and the inspection point cloud data 30, or the like.

A way of acquiring the reference point cloud data 20 and a way of acquiring the inspection point cloud data 30 may be the same or different from each other.

### <Generation of Difference Point Cloud Data 40: S104>

The difference data generation unit 2040 generates the difference point cloud data 40 (S104). Specifically, the difference data generation unit 2040 computes a difference in luminance between the reference point cloud data 20 and the inspection point cloud data 30 for each of the plurality of parts. Here, an existing technique can be used as a technique of obtaining data representing a difference in luminance for each of a plurality of measured parts from two pieces of point cloud data.

Suppose that the direction in which the electromagnetic wave is emitted by the measurement apparatus 200 is denoted by a pair (i, j) of the index i in the horizontal direction and the index j in the vertical direction. Further, a set of luminance data obtained from the reference point cloud data 20 is represented as B1={b1[i][j]|1<=i<=n, 1<=j<=m}, and a set of luminance data obtained from the inspection point cloud data 30 is represented as B2={b2[i][j]|1<=i<=n, 1<=j<=m}. In this case, the difference point cloud data 40 can be represented as

$$D = \{ d [ i ] [ j ] = b 2 [ i ] [ j ] - b 1 [ i ] [ j ] \vert \qquad 1 <= i < = n , \qquad 1 <= j <= m \} .$$

### <Detection of Excluded Part: S106>

The excluded part detection unit 2060 detects the excluded part by using the reference point cloud data 20 (S106). As described above, for example, the excluded part is a moving object part or a part prone to erroneous determination in the determination of whether the part is an abnormal part. In another example, the excluded part detection unit 2060 may determine point data having high likelihood that the measurement result is not correct (point data having high likelihood of representing noise) from the inspection point cloud data 30, and detect a part represented by that point data as an excluded part.

Here, the excluded part detection unit 2060 may handle only one type of parts among a plurality of types of parts that can be handled as excluded parts as excluded parts, or may handle two or more types of parts as excluded parts. Hereinafter, an example of the excluded parts is specifically described.

### <<Regarding Moving Object Part>>

For example, the excluded part detection unit 2060 detects a moving object part, which is a part whose position changes over time, from the target space by using the reference point cloud data 20, and handles the moving object part as an excluded part. As described above, the part detected as the moving object part is considered to be a portion of an object (for example, grass or tree) other than the target object 10. Therefore, by excluding the moving object part from an abnormality determination target, it is possible to avoid erroneous detection of an object other than the target object 10 as an abnormal part.

The moving object part is detected by using the plurality of pieces of reference point cloud data 20 generated based on results of measurement performed at different points in time. Therefore, the acquisition unit 2020 acquires the plurality of pieces of reference point cloud data 20.

The excluded part detection unit 2060 computes the magnitude of the difference in the three-dimensional position for each of the plurality of parts among the plurality of pieces of reference point cloud data 20. Then, the excluded part detection unit 2060 detects a part where the magnitude of the difference between the three-dimensional positions is equal to or more than a threshold, as a moving object part. The magnitude of the difference in the three-dimensional positions can be represented, for example, by a distance between the three-dimensional positions.

For example, as described above, when the measurement apparatus 200 emits electromagnetic waves in a plurality of directions, the excluded part detection unit 2060 compares the position data obtained by the electromagnetic waves emitted in the same direction among the plurality of pieces of reference point cloud data 20. As a more specific example, a set of position data indicated by first reference point cloud data 20 is represented by A1={a1[i][j]|1<=i<=n, 1<=j<=m}, and a set of position data indicated by second reference point cloud data 20 is represented by A2={a2[i][j]|1<=i<=n, 1<=j<=m}. In this case, the excluded part detection unit 2060 computes ∥a1[i][j]-a2[i][j]∥, which is the distance between a1[i][j] and a2[i][j], for each part (i.e., for each direction (i, j)).

The excluded part detection unit 2060 detects the moving object part by using the above-mentioned distance. For example, the moving object part is identified by a direction (i, j) the above-mentioned distance of which is equal to or more than a threshold. For example, in a case where a part detected as a moving object part is represented by a direction (u, v) (in a case where the distance ∥a1[u][v]-a2[u][v]∥ is equal to or larger than a threshold), the abnormal part detection unit 2080 excludes, among the difference point data included in the difference point cloud data D, d[u][v] from the detection target of the abnormal part when detecting the abnormal part.

Three or more pieces of reference point cloud data 20 may be used to detect the moving object part. In this case, for example, for each direction (i, j), the excluded part detection unit 2060 computes the size of the distribution of the position data indicated by each piece of reference point cloud data 20 in the direction. Then, the excluded part detection unit 2060 detects a direction in which the size of the distribution is equal to or larger than the threshold as a direction representing the moving object part.

Suppose that k pieces of reference point cloud data 20 (the first reference point cloud data 20, the second reference point cloud data 20, . . . , and the k-th reference point cloud data 20) are obtained. Then, suppose that sets of position data obtained therefrom are represented by A1={a1[i][j]|1<=i<=n, 1<=j<=m}, A2={a2[i][j]|1<=i<=n, 1<=j<=m}, . . . , and Ak={ak[i][j]|1<=<=n, 1<=j<=m}, respectively. In this case, for each direction (i, j), an index value (for example, a variance) representing the size of the distribution of k three-dimensional positions (a1[i][j], a2[i][j], . . . , ak[i][j]) is computed. Then, the excluded part detection unit 2060 detects a direction (i, j) in which the size of the distribution is equal to or larger than the threshold as a direction representing the moving object part. Note that an existing method can be used as a concrete method of computing the size of the distribution of the plurality of pieces of three-dimensional data.

In addition to the part detected as the moving object part by the above-described method, the excluded part detection unit 2060 may also handle another part estimated to be on the same object as that part, as the excluded part. According to this method, for example, when a branch or a leaf of a tree is detected as a moving object part, the remaining part such as a trunk of the tree can also be handled as an excluded part.

To do so, the excluded part detection unit 2060 clusters the plurality of point data included in the reference point cloud data 20 for pieces of point data representing the same object (for pieces of point data representing positions on the same object) as each other. Furthermore, for each piece of point data indicating the moving object part, the excluded part detection unit 2060 determines a cluster including that point data. Then, the excluded part detection unit 2060 detects a part represented by each piece of point data included in the determined clusters as an excluded part. Note that an existing method can be used as a concrete method of clustering the point cloud data for pieces of point data representing the same object.

### <<Regarding Part Prone to Erroneous Determination>>

In addition, for example, the excluded part detection unit 2060 detects a part prone to erroneous determination as an excluded part. In this way, it is possible to lower the likelihood that a part that is not an abnormal part is erroneously determined as an abnormal part.

Hereinafter, a plurality of specific examples of a part that is prone to erroneous determination and thus is handled as an excluded part will be described. Note that, among a plurality of examples of the part prone to erroneous determination described below, only one type may be handled as an excluded part, or any two or more types may be handled as excluded parts.

### <<<Part Having Large Incident Angle of Electromagnetic Wave>>>

The part prone to erroneous determination is, for example, a part where the incident angle of the electromagnetic wave emitted from the measurement apparatus 200 is large. The measurement apparatus 200 emits an electromagnetic wave in each of a plurality of directions. However, when the measurement apparatus 200 performs measurement at different points in time, even electromagnetic waves that are regarded as being emitted in the same direction (i, j) in the measurement result may have slight errors in the emission directions. In a part where the incident angle of the electromagnetic wave is large, it is likely that the positions of the object hit by the electromagnetic wave greatly different due to such errors in the emission directions.

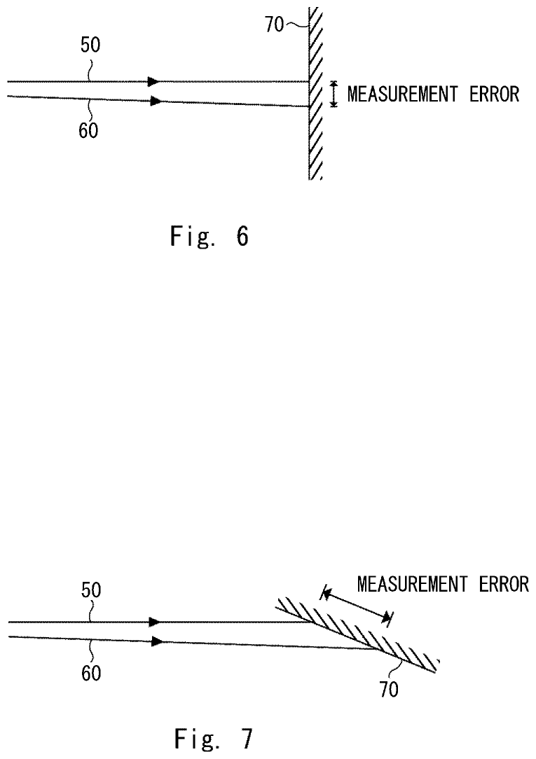

FIGS. 6 and 7 are diagrams illustrating the influence of the size of the incident angle of the electromagnetic wave on the measurement result. In FIGS. 6 and 7, an electromagnetic wave 50 represents an electromagnetic wave emitted in a direction (u, v) in measurement for obtaining the reference point cloud data 20. Meanwhile, an electromagnetic wave 60 represents an electromagnetic wave emitted in the direction (u, v) in the measurement for obtaining the inspection point cloud data 30. An object 70 is irradiated with both the electromagnetic wave 50 and the electromagnetic wave 60.

In the recording of the measurement apparatus 200 (that is, on the point cloud data), the electromagnetic wave 50 and the electromagnetic wave 60 are handled as being emitted in the same direction. However, actually, as illustrated in FIG. 6, there is a slight difference in the emission direction of these electromagnetic waves.

FIG. 6 illustrates a case where the incident angle of the electromagnetic wave is relatively small. Meanwhile, FIG. 7 illustrates a case where the incident angle of the electromagnetic wave is relatively large. In FIGS. 6 and 7, the difference between the direction of the electromagnetic wave 50 and the direction of the electromagnetic wave 60 is the same as each other. However, comparing FIGS. 6 and 7, in the case of FIG. 7 in which the incident angle of the electromagnetic wave is larger, the difference between the position on the object 70 irradiated with the electromagnetic wave 50 and the position on the object 70 irradiated with the electromagnetic wave 60 is larger as compared with the case of FIG. 6 in which the incident angle of the electromagnetic wave is smaller. From this, it can be seen that the difference in position data becomes larger for each measurement at a part where the incident angle of the electromagnetic wave is larger.

Therefore, for example, the excluded part detection unit 2060 estimates the incident angle of the electromagnetic wave for each of a plurality of parts (emission directions of the electromagnetic wave used for measurement) by using the reference point cloud data 20 or the inspection point cloud data 30. Then, the excluded part detection unit 2060 determines a part where the incident angle of the electromagnetic wave is equal to or larger than a threshold as an excluded part.

The incident angle is estimated as follows, for example. First, the excluded part detection unit 2060 computes, for each piece of point data included in the point cloud data, a normal vector of the object surface at the three-dimensional position indicated by the point data. Then, for each piece of point data, the excluded part detection unit 2060 computes an angle formed by the direction of the electromagnetic wave from which that point data is obtained and the direction of the normal vector computed for that point data as the incident angle of the electromagnetic wave.

Note that an existing method can be used as a method of computing the normal vector for each piece of point data of the point cloud data obtained from the measurement apparatus 200. For example, the excluded part detection unit 2060 computes a plane drawn by the three-dimensional position indicated by the point data for which the normal vector is desired to be computed and the three-dimensional position indicated by each of the plurality of point data near that point data. Then, the excluded part detection unit 2060 computes a vector orthogonal to this plane as a normal vector.

### <<<Edge>>>

A next example of a part prone to erroneous determination is an edge of an object. The magnitude of the luminance measured by using the electromagnetic wave is determined based on the intensity of the reflected light received by the measurement apparatus 200. At this point, in the edge portion of the object, a portion of the electromagnetic wave hits the object, and the other portion does not hit the object. Therefore, the magnitude of the measured luminance varies depending on how much of the emitted electromagnetic wave hits the object.

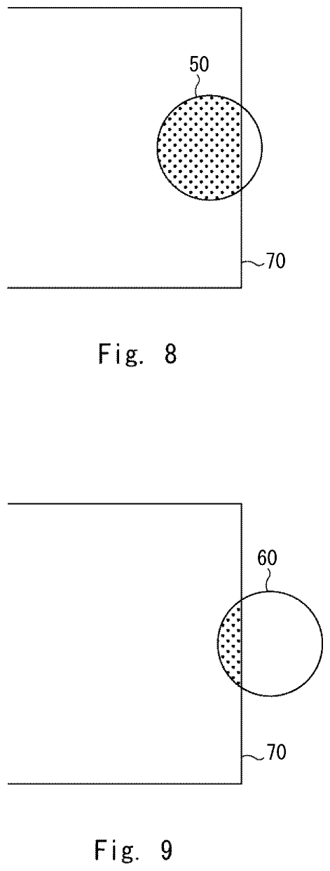

FIGS. 8 and 9 are diagrams illustrating a case where an edge of an object is irradiated with an electromagnetic wave. The electromagnetic wave 50 represents an electromagnetic wave emitted in a direction (u, v) in the measurement for obtaining the reference point cloud data 20. Meanwhile, an electromagnetic wave 60 represents an electromagnetic wave emitted in the direction (u, v) in the measurement for obtaining the inspection point cloud data 30. In FIGS. 8 and 9, the portion hit by the electromagnetic wave in the object 70 is represented by a dot pattern.

In FIG. 8, most of the electromagnetic wave 50 hits the object 70. Meanwhile, in FIG. 9, only a small part of the electromagnetic wave 60 hits the object 70. Therefore, it can be argued that the magnitude of the luminance measured by receiving the reflected wave of the electromagnetic wave 50 and the magnitude of the luminance measured by receiving the reflected wave of the electromagnetic wave 60 are greatly different from each other. That is, the luminance data indicated by the reference point cloud data 20 for the direction (u, v) and the luminance data indicated by the inspection point cloud data 30 for the direction (u, v) are considered to be greatly different from each other.

As described above, at the edge of the object, it is likely that the magnitude of the measured luminance greatly differs due to errors in the emission directions of the electromagnetic wave. Therefore, when the point data obtained for the edge of the object is used, the difference in luminance between the reference point cloud data 20 and the inspection point cloud data 30 becomes larger even for a part that is not actually an abnormal part, and the likelihood that erroneous detection occurs for the abnormal part increases.

Therefore, the excluded part detection unit 2060 detects a part representing the edge of the object by using the reference point cloud data 20 or the inspection point cloud data 30 and handles the part as an excluded part. Specifically, the excluded part detection unit 2060 determines whether each piece of point data represents an edge of an object by performing the following process on each piece of point data included in the point cloud data.

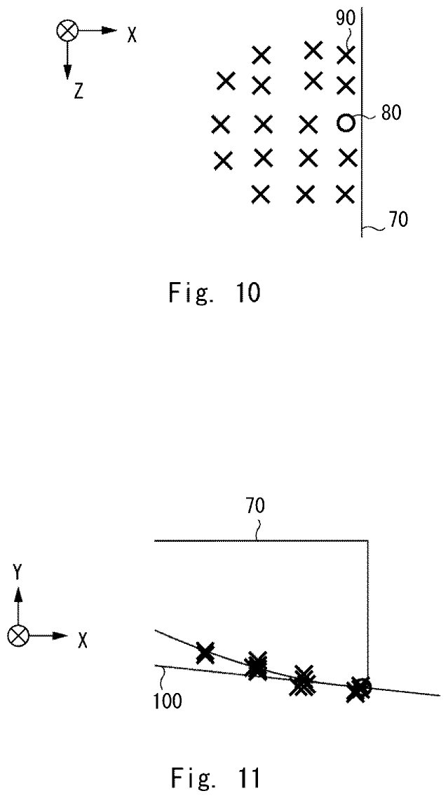

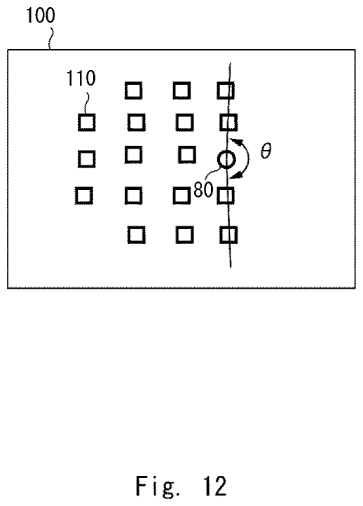

FIGS. 10 to 12 are diagrams conceptually illustrating a process of determining whether point data represents a point (three-dimensional position) on an edge of an object. FIG. 10 is a front view of the object 70. FIG. 11 is a plan view of the object 70. A target point 80 represented by a circle is a point to be determined as to whether that point is a point on the edge of the object 70 among the points represented by the point cloud data. Neighboring points 90 indicated by cross marks represent points positioned near the target point 80 among points indicated by the point cloud data.

First, the excluded part detection unit 2060 determines the neighboring points 90 from the points represented by the point cloud data. Specifically, when denoting the three-dimensional position of the target point 80 by b[u][v] and the threshold of the distance representing the vicinity by th, among the points represented by the point cloud data, the excluded part detection unit 2060 determines a point b[i][j] satisfying ∥b[u][v]−b[i][j]∥<=th as the neighboring point 90.

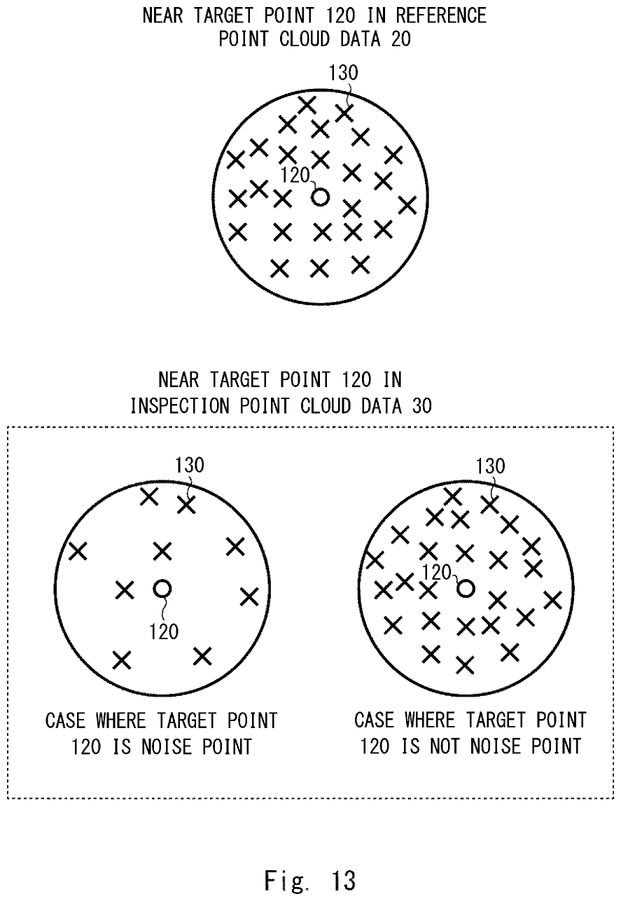

Next, the excluded part detection unit 2060 determines a plane 100 in contact with the object 70 at the target point 80 by using the target point 80 and the neighboring point 90. Furthermore, the excluded part detection unit 2060 projects each of the neighboring points 90 onto the plane 100. FIG. 12 is a diagram illustrating the plane 100 on which the neighboring point 90 is projected. Each point obtained by projecting the neighboring point 90 onto the plane 100 is drawn as a projection point 110.

The excluded part detection unit 2060 determines whether the target point 80 is a point on the edge based on the positional relationship between the target point 80 and the projection point 110. Specifically, the excluded part detection unit 2060 computes an opening angle (θ in FIG. 12) by using the target point 80 and the projection point 110 and determines whether the opening angle is a threshold or more. When the opening angle is the threshold or more, the excluded part detection unit 2060 determines that the target point 80 is on the edge. Therefore, the target point 80 is handled as an excluded part. For example, when the target point 80 is b[u][v], the data for the direction (u, v) in the difference point cloud data 40 is excluded from the abnormality detection target. On the other hand, when the opening angle is less than the threshold, the excluded part detection unit 2060 determines that the target point 80 is not on the edge.

When it is determined that the target point 80 is on the edge, the excluded part detection unit 2060 may also handle each neighboring point 90 as an excluded part in addition to the target point 80.

Here, an example of a method of computing the opening angle described above is described. First, the excluded part detection unit 2060 computes, for each projection point 110, a unit vector from the target point 80 toward the projection point 110. Next, the excluded part detection unit 2060 computes an average vector of all the computed unit vectors. Furthermore, for each unit vector, the excluded part detection unit 2060 computes the size of a rotation angle from the average vector to the unit vector. When the size of the rotation angle from the reference direction to the average vector is larger than the size of the rotation angle from the reference direction (for example, horizontally rightward) to the unit vector, the rotation angle from the average vector to the unit vector takes a negative value.

The excluded part detection unit 2060 extracts the maximum value and the minimum value from the plurality of computed rotation angles and computes a value obtained by subtracting the minimum value from the maximum value. Then, the excluded part detection unit 2060 computes a value obtained by subtracting the difference between the maximum value and the minimum value of the rotation angle from 360° as the opening angle.

### <<Removal of Noise>>

In addition, for example, the excluded part detection unit 2060 determines point data whose measurement result is likely not correct (point data that is likely to represent noise) from the inspection point cloud data 30, and detects a part represented by the point data as an excluded part. For example, in a case where the measurement result represented by the point data p[u][v] is considered to be correct, d[u][v] of the difference point cloud data 40 is excluded from the abnormality detection target. Hereinafter, point data whose measurement result is likely not correct is referred to as noise point data. Furthermore, the position represented by the noise point data is referred to as a noise point.

For example, the excluded part detection unit 2060 determines the noise point data by comparing the densities of the point clouds between the reference point cloud data 20 and the inspection point cloud data 30. FIG. 13 is a diagram illustrating a difference in the density of the point cloud between the reference point cloud data 20 and the inspection point cloud data 30. In FIG. 13, a target point 120 is a determination target as to whether it is a noise point. Neighboring points 130 are points positioned near the target point 120.

Here, the position data indicated by the noise point data represents a position different from the original position of the measured part. Therefore, it can be argued that the number of the neighboring points 130 decreases in a case where the target point 120 is a noise point. Therefore, it can be argued that, when the target point 120 in the inspection point cloud data 30 is a noise point, the density of the point cloud included near the target point 120 is lower than the actual density, and thus the density is lower than the density of the point cloud included near the target point 120 in the reference point cloud data 20. On the other hand, it can be argued that, when the target point 120 is not a noise point, the density of the point cloud included near the target point 120 in the inspection point cloud data 30 is substantially the same as the density of the point cloud included near the target point 120 in the reference point cloud data 20.

Therefore, the excluded part detection unit 2060 computes the density (for example, the number of the neighboring points 130) of the point cloud positioned near the point represented by the point data for each piece of point data representing the same part between the reference point cloud data 20 and the inspection point cloud data 30, and determines whether the difference in the density is large. When the difference in density is large, the excluded part detection unit 2060 determines that the target point 120 is a noise point. On the other hand, when the difference in density is not large, the excluded part detection unit 2060 determines that the target point 120 is not a noise point.

The degree of the difference in density can be represented by, for example, a density ratio. Suppose that the density of the point cloud positioned near the target point 120 in the reference point cloud data 20 is denoted by ρ1, and the density of the point cloud positioned near the target point 120 in the inspection point cloud data 30 is denoted by ρ2. In this case, the density ratio ρ2/ρ1 can be used as a value representing the degree of the difference in density.

### <Detection of Abnormal Part: S108>

The abnormal part detection unit 2080 detects an abnormal part by using data other than the excluded part in the point data included in the difference point cloud data 40 (S108). Suppose that, as described above, the difference point cloud data 40 is represented by D={d[i][j]|1<=i<=n, 1<=j<=m}. In this case, the excluded part detection unit 2060 determines whether d[i][j] other than the part detected as the excluded part is an abnormal part. For example, when the excluded part is represented by the direction (u, v), d[v][v] is excluded from the abnormality detection target among the point data included in the difference point cloud data 40.

Here, an existing method can be used as a method of detecting an abnormal part by using difference in luminance obtained for a specific part. For example, when the difference d[u][v] in the luminance for a certain part (u, v) is equal to or larger than a threshold, the abnormal part detection unit 2080 detects the part (u, v) as an abnormal part.

### <Output of Result>

The abnormality detection apparatus 2000 outputs output information representing a result of the processes. The output information is information capable of identifying an abnormal part. For example, the output information indicates information representing an abnormal part. Here, the abnormal part may be represented by a pair of indexes indicating a measurement direction or may be represented by other methods. In the former case, for example, when the luminance data d[u][v] is equal to or larger than a threshold, the abnormal part is represented by a direction (u, v). On the other hand, in the latter case, the abnormal part in the similar case is represented by the three-dimensional position b[u][v] indicated by the inspection point cloud data 30 with respect to the direction (u, v).

In addition, for example, the output information may indicate point cloud data that is obtained by processing the inspection point cloud data 30 so that an abnormal part and other parts can be distinguished therein. In this case, for example, the abnormality detection apparatus 2000 generates point cloud data in which the position data and the color data are associated with each other, from the inspection point cloud data 30. Hereinafter, this point cloud data is referred to as display point cloud data.

The abnormality detection apparatus 2000 generates point data to be included in the display point cloud data from each piece of point data included in the inspection point cloud data 30. Suppose that the inspection point cloud data 30 is represented as P={p[i][j]=(a[i][j], b[i][j])|1<=i<=n, 1<=j<=m} as described above. In this case, the display point cloud data can be represented as Q={q[i][j]=(a[i][j], c[i][j])|1<=i<=n, 1<=j<=m}. Here, c[i][i] denotes color data for the direction (i, j). The position data indicated by each piece of point data of the display point cloud data is the position data indicated by the point data of the corresponding inspection point cloud data 30.

Here, a method of generating color data is described. For example, in the display point cloud data, the color data of a part other than the abnormal part indicates the luminance level of the part in gray scale. That is, the color data indicated by the point data of the part other than the abnormal part is represented in a color closer to black as the luminance indicated by the inspection point cloud data 30 for the part is lower, and is represented in gray closer to white as the luminance indicated by the inspection point cloud data 30 for the part is higher.

Meanwhile, in the display point cloud data, the color data of the abnormal part indicates a specific color (for example, red) other than gray. At this time, the color data of the abnormal part may be fixed regardless of the luminance level of the abnormal part or may be set to a color corresponding to the luminance of the abnormal part. In the latter case, for example, the color data of the abnormal part indicates a color with higher luminance as the luminance indicated by the inspection point cloud data 30 for the part is higher. Suppose that color data of an abnormal part is represented only by a red component among three primary colors of red, green, and blue. In this case, the color data of the abnormal part indicates a color having a larger red component as the luminance level indicated for that abnormal part by the inspection point cloud data 30 is higher.

By viewing display data in which the display point cloud data generated in this manner is plotted in a virtual three-dimensional space, the user of the abnormality detection apparatus 2000 can easily grasp which portion of the object, such as the target object 10, present in the target space is the abnormal part. If the luminance of the color data is made higher as the luminance of the abnormal part is higher, the degree of abnormality can be easily grasped by viewing the display data.

In the output information, the excluded part may be indicated in a manner distinguishable from other data. In this case, for example, in the above-described display point cloud data, the color data for the excluded part is represented by a specific color different from the color used for the color data of the abnormal part. For example, the color data of the abnormal part is represented by using only a red component, and the color data of the excluded part is represented by using only a blue component. In this way, the user of the abnormality detection apparatus 2000 can easily grasp the part excluded from the determination target of the abnormal part.

The output information is out in an arbitrary way. For example, the output information is put into an arbitrary storage unit. In another example, the output information is transmitted to another apparatus. In addition, for example, the output information may be displayed on display apparatus. Here, when the output information is displayed on the display apparatus, it is preferable to display the display data in which the display point cloud data is plotted in the virtual three-dimensional space described above.

Although the present invention is described above with reference to the example embodiments, the present invention is not limited to the above-described example embodiments. Various changes that can be understood by those skilled in the art can be made to the configurations and details of the present invention within the scope of the present invention.

In the above-described example, the program includes a group of instructions (or software codes) for causing a computer to execute one or more functions described in the example embodiments when being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD), or other memory technology, a CD-ROM, a digital versatile disc (DVD), a Blu-ray (registered trademark) disk, or other optical disk storage, and a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium include electrical, optical, acoustic, signals, or propagated signals in other forms.

A portion or all of the example embodiments described above can be described as in the following supplementary notes but the present invention is not limited to the following notes.

### (Supplementary Note 1)

An abnormality detection apparatus comprising:
an acquisition unit configured to acquire reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts;
a difference data generation unit configured to generate difference point cloud data representing a difference in luminance between the reference time and the time of inspection for each of the parts by using the reference point cloud data and the inspection point cloud data;
an excluded part detection unit configured to detect a moving object part, which is a part whose position changes over time, from the plurality of parts as an excluded part to be excluded from a detection target of an abnormal part; and
an abnormal part detection unit configured to detect an abnormal part of the target object at the time of inspection from the parts other than the excluded parts from the plurality of parts by using the difference point cloud data.

### (Supplementary Note 2)

The abnormality detection apparatus according to claim 1,
wherein the excluded part detection unit performs:
   dividing a plurality of pieces of the point data included in the reference point cloud data into clusters for pieces of the point data representing parts on the same object; and
   determining the point data included in the same cluster as the point data representing the moving object part, and detecting the moving object part and the part represented by the determined point data as the excluded parts.

### (Supplementary Note 3)

The abnormality detection apparatus according to claim 1 or 2,
wherein the excluded part detection unit further detects, as the excluded part, a part prone to erroneous determination in determination of whether the part is an abnormal part, from the plurality of parts.

### (Supplementary Note 4)

The abnormality detection apparatus according to claim 3,
wherein the reference point cloud data and the inspection point cloud data are generated by using a measurement apparatus that emits an electromagnetic wave in each of a plurality of directions, and
wherein the excluded part detection unit uses the reference point cloud data or the inspection point cloud data to determine the part where an incident angle of the electromagnetic wave for that part equal to or larger than a threshold among the plurality of parts, and detects the determined part as the excluded part.

### (Supplementary Note 5)

The abnormality detection apparatus according to claim 3,
wherein the excluded part detection unit determines a part positioned at an edge of an object by using the reference point cloud data or the inspection point cloud data, and detects the determined part as the excluded part.

### (Supplementary Note 6)

The abnormality detection apparatus according to any one of claims 1 to 5,
wherein the excluded part detection unit performs:
   computing, for each piece of the point data included in the reference point cloud data, a first density representing the number of pieces of the point data indicating a three-dimensional position at which a distance from the three-dimensional position represented by the point data is equal to or larger than a threshold;
   computing, for each piece of the point data included in the inspection point cloud data, a second density representing the number of pieces of the point data indicating a three-dimensional position at which a distance from the three-dimensional position represented by the point data is equal to or larger than a threshold; and
   further detecting, as the excluded part, a part where a degree of a difference between the first density and the second density is equal to or larger than a threshold.

### (Supplementary Note 7)

A control method executed by a computer, the control method comprising:
an acquisition step of acquiring reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts;
a difference data generation step of generating difference point cloud data representing a difference in luminance between the reference time and the time of inspection for each of the parts by using the reference point cloud data and the inspection point cloud data;
an excluded part detection step of detecting a moving object part, which is a part whose position changes over time, from the plurality of parts as an excluded part to be excluded from a detection target of an abnormal part; and
an abnormal part detection step of detecting an abnormal part of the target object at the time of inspection from the parts other than the excluded parts from the plurality of parts by using the difference point cloud data.

### (Supplementary Note 8)

The control method according to claim 7,
wherein in the excluded part detection step:
   dividing a plurality of pieces of the point data included in the reference point cloud data into clusters for pieces of the point data representing parts on the same object; and
   determining the point data included in the same cluster as the point data representing the moving object part, and detecting the moving object part and the part represented by the determined point data as the excluded parts.

### (Supplementary Note 9)

The control method according to claim 7 or 8,
wherein in the excluded part detection step, further detecting, as the excluded part, a part prone to erroneous determination in determination of whether the part is an abnormal part from the plurality of parts.

### (Supplementary Note 10)

The control method according to claim 9,
wherein the reference point cloud data and the inspection point cloud data are generated by using measurement apparatus that emits an electromagnetic wave in each of a plurality of directions, and
wherein in the excluded part detection step, using the reference point cloud data or the inspection point cloud data to determine the part where an incident angle of the electromagnetic wave for that part is equal to larger than a threshold among the plurality of parts, and detecting the determined part as the excluded part.

### (Supplementary Note 11)

The control method according to claim 9,
wherein in the excluded part detection step, determining a part positioned at an edge of an object by using the reference point cloud data or the inspection point cloud data, and detecting the determined part as the excluded part.

### (Supplementary Note 12)

The control method according to any one of claims 7 to 11,
wherein in the excluded part detection step:
   computing, for each piece of the point data included in the reference point cloud data, a first density representing the number of pieces of the point data indicating a three-dimensional position at which a distance from the three-dimensional position represented by the point data is equal to larger than a threshold;
   computing, for each piece of the point data included in the inspection point cloud data, a second density representing the number of pieces of the point data indicating a three-dimensional position at which a distance from the three-dimensional position represented by the point data is equal to or larger than a threshold; and
   further detecting, as the excluded part, a part where a degree of a difference between the first density and the second density is equal to or larger than a threshold.

### (Supplementary Note 13)

A computer-readable medium that stores a program causing a computer to execute:
an acquisition step of acquiring reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts;
a difference data generation step of generating difference point cloud data representing a difference in luminance between the reference time and the time of inspection for each of the parts by using the reference point cloud data and the inspection point cloud data;
an excluded part detection step of detecting a moving object part, which is a part whose position changes over time, from the plurality of parts as an excluded part to be excluded from a detection target of an abnormal part; and
an abnormal part detection step of detecting an abnormal part of the target object at the time of inspection from the part other than the excluded part from the plurality of parts by using the difference point cloud data.

### (Supplementary Note 14)

The computer-readable medium according to claim 13,
wherein in the excluded part detection step:
   dividing a plurality of pieces of the point data included in the reference point cloud data into clusters for pieces of the point data representing parts on the same object; and
   determining the point data included in the same cluster as the point data representing the moving object part, and detecting the moving object part and the part represented by the determined point data as the excluded parts.

### (Supplementary Note 15)

The computer-readable medium according to claim 13 or 14,
wherein in the excluded part detection step, further detecting, as the excluded part, a part prone to erroneous determination in determination of whether the part is an abnormal part from the plurality of parts.

### (Supplementary Note 16)

The computer-readable medium according to claim 15,
wherein the reference point cloud data and the inspection point cloud data are generated by using a measurement apparatus that emits an electromagnetic wave in each of a plurality of directions, and
wherein in the excluded part detection step, using the reference point cloud data or the inspection point cloud data to determine the part where an incident angle of the electromagnetic wave for that part is equal to or larger than threshold among the plurality of parts, and detecting the determined part as the excluded part.

### (Supplementary Note 17)

The computer-readable medium according to claim 15,
wherein in the excluded part detection step, determining a part positioned at an edge of an object by using the reference point cloud data or the inspection point cloud data, and detecting the determined part as the excluded part.

### (Supplementary Note 18)

The computer-readable medium according to any one of claims 13 to 17,
wherein in the excluded part detection step:
   computing for each piece of the point data included in the reference point cloud data, a first density representing the number of pieces of the point data indicating a three-dimensional position at which a distance from the three-dimensional position represented by the point data is equal to or larger than threshold;
   computing for each piece of the point data included in the inspection point cloud data, a second density representing the number of pieces of the point data indicating a three-dimensional position at which a distance from the three-dimensional position represented by the point data is equal to or larger than threshold; and
   further detecting, as the excluded part, a part where a degree of a difference between the first density and the second density is equal to or larger than threshold.

### REFERENCE SIGNS LIST

10 TARGET OBJECT
20 REFERENCE POINT CLOUD DATA
30 INSPECTION POINT CLOUD DATA
40 DIFFERENCE POINT CLOUD DATA
50 ELECTROMAGNETIC WAVE
60 ELECTROMAGNETIC WAVE
70 OBJECT
80 TARGET POINT
90 NEIGHBORING POINT
100 PLANE
110 PROJECTION POINT
120 TARGET POINT
130 NEIGHBORING POINT
200 MEASUREMENT APPARATUS
500 COMPUTER
502 BUS
504 PROCESSOR
506 MEMORY
508 STORAGE DEVICE
510 INPUT/OUTPUT INTERFACE
512 NETWORK INTERFACE
2000 ABNORMALITY DETECTION APPARATUS
2020 ACQUISITION UNIT
2040 DIFFERENCE DATA GENERATION UNIT
2060 EXCLUDED PART DETECTION UNIT
2080 ABNORMAL PART DETECTION UNIT

What is claimed is:

1. An abnormality detection apparatus comprising:
at least one memory storing instructions; and
at least one processor that is configured to execute the instructions to:
acquire reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts;
generate difference point cloud data representing a difference in luminance between the reference time and the time of inspection for each of the parts by using the reference point cloud data and the inspection point cloud data;
detect a moving object part, which is a part whose position changes over time, from the plurality of parts as an excluded part to be excluded from a detection target of an abnormal part; and
detect an abnormal part of the target object at the time of inspection from the parts other than the excluded parts from the plurality of parts by using the difference point cloud data.

2. The abnormality detection apparatus according to claim 1,
wherein the detection of the excluded part includes:
dividing a plurality of pieces of the point data included in the reference point cloud data into clusters for pieces of the point data representing parts on the same object; and
determining the point data included in the same cluster as the point data representing the moving object part, and detecting the moving object part and the part represented by the determined point data as the excluded parts.

3. The abnormality detection apparatus according to claim 1,
wherein the detection of the excluded part includes further detecting, as the excluded part, a part prone to erroneous determination in determination of whether the part is an abnormal part, from the plurality of parts.

4. The abnormality detection apparatus according to claim 3,
wherein the reference point cloud data and the inspection point cloud data are generated by using a measurement apparatus that emits an electromagnetic wave in each of a plurality of directions, and
wherein the detection of the excluded part includes using the reference point cloud data or the inspection point cloud data to detect, as the part prone to the erroneous determination, a part where an incident angle of the electromagnetic wave for that part equal to or larger than a threshold.

5. The abnormality detection apparatus according to claim 3,
wherein the detection of the excluded part includes detecting, as the part prone to the erroneous determination, a part positioned at an edge of an object by using the reference point cloud data or the inspection point cloud data.

6. The abnormality detection apparatus according to claim 1,
wherein the detection of the excluded part includes:
computing, for each piece of the point data included in the reference point cloud data, a first density representing the number of pieces of the point data indicating a three-dimensional position at which a distance from the three-dimensional position represented by the point data is equal to or larger than a threshold;
computing, for each piece of the point data included in the inspection point cloud data, a second density representing the number of pieces of the point data indicating a three-dimensional position at which a distance from the three-dimensional position represented by the point data is equal to or larger than a threshold; and
further detecting, as the excluded part, a part where a degree of a difference between the first density and the second density is equal to or larger than a threshold.

7. A control method executed by a computer, the control method comprising:
acquiring reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts;
generating difference point cloud data representing a difference in luminance between the reference time and the time of inspection for each of the parts by using the reference point cloud data and the inspection point cloud data;
detecting a moving object part, which is a part whose position changes over time, from the plurality of parts as an excluded part to be excluded from a detection target of an abnormal part; and
detecting an abnormal part of the target object at the time of inspection from the parts other than the excluded parts from the plurality of parts by using the difference point cloud data.

8. The control method according to claim 7,
wherein the detection of the excluded part includes:
dividing a plurality of pieces of the point data included in the reference point cloud data into clusters for pieces of the point data representing parts on the same object; and
determining the point data included in the same cluster as the point data representing the moving object part, and detecting the moving object part and the part represented by the determined point data as the excluded parts.

9. The control method according to claim 7,
wherein the detection of the excluded part includes further detecting, as the excluded part, a part prone to erroneous determination in determination of whether the part is an abnormal part from the plurality of parts.

10. The control method according to claim 9,
wherein the reference point cloud data and the inspection point cloud data are generated by using measurement apparatus that emits an electromagnetic wave in each of a plurality of directions, and
wherein the detection of the excluded part includes using the reference point cloud data or the inspection point cloud data to detect, as the part prone to the erroneous determination, a part where an incident angle of the electromagnetic wave for that part is equal to larger than a threshold.

11. The control method according to claim 9,
wherein the detection of the excluded part includes detecting, as the part prone to the erroneous determination, a part positioned at an edge of an object by using the reference point cloud data or the inspection point cloud data.

12. The control method according to claim 7,
wherein the detection of the excluded part includes:
computing, for each piece of the point data included in the reference point cloud data, a first density representing the number of pieces of the point data indicating a three-dimensional position at which a distance from the three-dimensional position represented by the point data is equal to larger than a threshold;
computing, for each piece of the point data included in the inspection point cloud data, a second density representing the number of pieces of the point data indicating a three-dimensional position at which a distance from the three-dimensional position represented by the point data is equal to or larger than a threshold; and
further detecting, as the excluded part, a part where a degree of a difference between the first density and the second density is equal to or larger than a threshold.

13. A non-transitory computer-readable medium that stores a program causing a computer to execute:
acquiring reference point cloud data indicating point data representing a three-dimensional position and luminance at reference time for each of a plurality of parts in a space including a target object, and inspection point cloud data indicating point data representing a three-dimensional position and luminance at time of inspection for each of the plurality of parts;
generating difference point cloud data representing a difference in luminance between the reference time and the time of inspection for each of the parts by using the reference point cloud data and the inspection point cloud data;
detecting a moving object part, which is a part whose position changes over time, from the plurality of parts as an excluded part to be excluded from a detection target of an abnormal part; and
detecting an abnormal part of the target object at the time of inspection from the part other than the excluded part from the plurality of parts by using the difference point cloud data.

14. The computer-readable medium according to claim 13,
wherein the detection of the excluded part includes:
dividing a plurality of pieces of the point data included in the reference point cloud data into clusters for pieces of the point data representing parts on the same object; and
determining the point data included in the same cluster as the point data representing the moving object part, and detecting the moving object part and the part represented by the determined point data as the excluded parts.

15. The computer-readable medium according to claim 13,
wherein the detection of the excluded part includes further detecting, as the excluded part, a part prone to erroneous determination in determination of whether the part is an abnormal part from the plurality of parts.

16. The computer-readable medium according to claim 15,
wherein the reference point cloud data and the inspection point cloud data are generated by using a measurement apparatus that emits an electromagnetic wave in each of a plurality of directions, and
wherein the detection of the excluded part includes using the reference point cloud data or the inspection point cloud data to detect, as the part prone to the erroneous determination, a part where an incident angle of the electromagnetic wave for that part is equal to or larger than threshold.

17. The computer-readable medium according to claim 15,
wherein the detection of the excluded part includes detecting, as the part prone to the erroneous determination, a part positioned at an edge of an object by using the reference point cloud data or the inspection point cloud data.

18. The computer-readable medium according to claim 13,
wherein the detection of the excluded part includes:
computing for each piece of the point data included in the reference point cloud data, a first density representing the number of pieces of the point data indicating a three-dimensional position at which a distance from the three-dimensional position represented by the point data is equal to or larger than threshold;
computing for each piece of the point data included in the inspection point cloud data, a second density representing the number of pieces of the point data indicating a three-dimensional position at which a distance from the three-dimensional position represented by the point data is equal to or larger than threshold; and
further detecting, as the excluded part, a part where a degree of a difference between the first density and the second density is equal to or larger than threshold.
